(19) United States
(12) Patent Application Publication
(10) Pub. No.: US 2016/0210988 A1
(43) Pub. Date: Jul. 21, 2016

(54) DEVICE AND METHOD FOR SOUND CLASSIFICATION IN REAL TIME

(71) Applicant: KOREA INSTITUTE OF SCIENCE AND TECHNOLOGY, Seoul (KR)

(72) Inventors: Yoonseob LIM, Seoul (KR); Jongsuk CHOI, Seoul (KR)

(73) Assignee: KOREA INSTITUTE OF SCIENCE AND TECHNOLOGY, Seoul (KR)

(21) Appl. No.: 14/950,344

(22) Filed: Nov. 24, 2015

(30) Foreign Application Priority Data
Jan. 19, 2015 (KR) 10-2015-0008592

(51) Int. Cl. G10L 25/84; G10L 25/18; G10L 25/24

(52) U.S. Cl. CPC G10L 25/84; G10L 25/24; G10L 25/18

(57) ABSTRACT

A sound source classification step according to an exemplary embodiment of the present disclosure includes the steps for detecting a sound stream for a preset period when a sound signal is generated, dividing the detected sound stream into a plurality of sound frames and extracting a sound source feature for each of the plurality of sound frames, and classifying each of the sound frames into one of pre-stored reference sound sources based on the extracted sound source feature, analyzing a correlation between the classified reference sound sources using the classification results, and classifying the sound stream using the analyzed correlation.

### CROSS-REFERENCE TO RELATED APPLICATION

This application claims priority to Korean Patent Application No. 10-2015-0008592, filed on Jan. 19, 2015, and all the benefits accruing therefrom under 35 U.S.C. §119, the contents of which in its entirety are herein incorporated by reference.

### BACKGROUND

1. Field

The present disclosure relates to a device and method for sound classification, and more particularly, to a device and method for classifying sounds generated from real life environment in real time using a correlation between sound sources.

[Description about National Research and Development Support]

This study was supported by Project No. 1415135316 and No. 2MR1960 of Ministry of Trade, Industry and Energy under the superintendence of Korea Institute of Science and Technology.

2. Description of the Related Art

With the development of sound signal processing technology, techniques for automatically classifying sound sources from real environment have been developed. These techniques for automatic sound source classification have applications in various fields including sound recognition, situation detection, and context awareness, so their significance is increasingly growing.

However, because conventional techniques for sound source classification classify sound sources through a complex process using a Mel Frequency Cepstral Coefficient (MFCC) feature and a Hidden Markov Model (HMM) classifier, they are incompetent for showing real-time performance to be used in the field of applications in real environment.

### RELATED LITERATURES

### Patent Literature

(Patent Literature 1) Korean Unexamined Patent Publication No. 10-2005-0054399

### SUMMARY

The present disclosure is directed to providing a device and method for sound classification with an increased computational speed to classify various types of sound sources generated from real environment in real time, and enhanced recognition performance to accurately classify various types of sound sources.

According to one aspect of the present disclosure, there is provided a sound classification device including a sound source detection unit to detect a sound stream for a preset period when a sound signal is generated, a sound source feature extraction unit to divide the detected sound stream into a plurality of sound frames, and extract a sound source feature for each of the plurality of sound frames, and a sound source classification unit to classify each of the sound frames into one of pre-stored reference sound sources based on the extracted sound source feature, analyze a correlation between the classified reference sound sources using the classification results, and finally classify the sound stream using the analyzed correlation.

According to one aspect of the present disclosure, the sound source detection unit may detect the sound stream when a difference between a amplitude of the sound signal and a amplitude of a background noise signal is greater than a preset detection threshold.

According to one aspect of the present disclosure, the sound source feature extraction unit may extract the sound source feature for each of the plurality of sound frames by a Gammatone Frequency Cepstral Coefficient (GFCC) technique.

According to one aspect of the present disclosure, the sound source classification unit may classify each of the sound frames into one of the pre-stored reference sound sources based on the extracted sound source feature, using a multi-class linear Support Vector Machine (SVM) classifier.

According to one aspect of the present disclosure, the sound source classification unit may analyze the correlation between the classified reference sound sources by calculating a sound source selection ratio representing a sound source selection ratio of each of the reference sound sources and a sound source correlation ratio representing a correlation ratio between the reference sound sources using the classification results.

According to one aspect of the present disclosure, the sound source classification unit may calculate a joint ratio that equals the corresponding sound source selection ratio multiplied by the corresponding sound source correlation ratio for each of the reference sound sources, and may finally classify the sound stream into one of the classified reference sound sources based on the joint ratio.

According to one aspect of the present disclosure, the sound source classification unit may compare a maximum value of the joint ratio to a preset classification threshold, and when the maximum value of the joint ratio is greater than the classification threshold, may finally classify the sound stream into the reference sound source having the maximum value of the joint ratio.

According to one aspect of the present disclosure, the sound source classification unit may finally classify the sound stream into an unclassified sound source that is not classified by the reference sound sources, when the maximum value of the joint ratio is smaller than the classification threshold.

According to one aspect of the present disclosure, the sound source classification unit may provide a user with the reference sound sources having top three values of the joint ratios together with the corresponding values of the joint ratios, when the sound stream is finally classified into the unclassified sound source.

According to one aspect of the present disclosure, there is provided a sound classification method including detecting a sound stream for a preset period when a sound signal is generated, dividing the detected sound stream into a plurality of sound frames, and extracting a sound source feature for each of the plurality of sound frames, and classifying each of the sound frames into one of pre-stored reference sound sources based on the extracted sound source feature, analyzing a correlation between the classified reference sound sources using the classification results, and classifying the sound stream using the analyzed correlation.

According to one aspect of the present disclosure, the detecting of the sound source stream may include detecting the sound stream when a difference between a amplitude of the sound signal and a amplitude of a background noise signal is greater than a preset detection threshold.

According to one aspect of the present disclosure, the extracting of the sound source feature may include extracting the sound source feature for each of the plurality of sound frames by a GFCC technique.

According to one aspect of the present disclosure, the classifying of the sound stream may include classifying each of the sound frames into one of the pre-stored reference sound sources based on the extracted sound source feature, using a multi-class linear SVM classifier.

According to one aspect of the present disclosure, the classifying of the sound stream may include analyzing the correlation between the classified reference sound sources by calculating a sound source selection ratio representing a sound source selection ratio of each of the reference sound sources and a sound source correlation ratio representing a correlation ratio between the reference sound sources using the classification results.

According to one aspect of the present disclosure, the classifying of the sound stream may include calculating a joint ratio that equals the corresponding sound source selection ratio multiplied by the corresponding sound source correlation ratio for each of the reference sound sources, and finally classifying the sound stream into one of the classified reference sound sources based on the joint ratio.

According to one aspect of the present disclosure, the classifying of the sound stream may include comparing a maximum value of the joint ratio to a preset classification threshold, and when the maximum value of the joint ratio is greater than the classification threshold, finally classifying the sound stream into the reference sound source having the maximum value of the joint ratio.

According to one aspect of the present disclosure, the classifying of the sound stream may include finally classifying the sound stream into an unclassified sound source that is not classified by the reference sound sources, when the maximum value of the joint ratio is smaller than the classification threshold.

According to one aspect of the present disclosure, the classifying of the sound stream may include providing a user with the reference sound sources having top three values of the joint ratios together with the corresponding values of the joint ratios, when the sound stream is finally classified into the unclassified sound source.

According to the present disclosure, a sound source classification system with enhanced recognition may be implemented as compared to traditional technology. Through this, as opposed to traditional technology, sounds generated from real environment as well as laboratory environment may be accurately classified.

Also, a sound source classification system with an improved computational speed may be implemented as compared to traditional technology. Through this, as opposed to traditional technology, real-time sound source classification may be enabled, so it can be easily applied to child monitoring devices and closed-circuit television (CCTV) systems for emergency recognition.

### BRIEF DESCRIPTION OF THE DRAWINGS

FIG. 1 is a diagram showing configuration of a sound classification device according to an exemplary embodiment of the present disclosure.

FIG. 2 is a flowchart of a sound classification method according to an exemplary embodiment of the present disclosure.

FIG. 3 is a detailed flowchart showing a sound source classification step in a sound classification method according to an exemplary embodiment of the present disclosure.

FIG. 4A shows an exemplary waveform of a sound stream detected by a sound source detection unit according to an exemplary embodiment of the present disclosure, and FIG. 4B shows exemplary feature space representation of a sound source feature extracted from the sound stream of FIG. 4A by a sound source feature extraction unit.

FIG. 5 shows an exemplary correlation ratio matrix.

FIG. 6 is a diagram showing an exemplary sound source correlation ratio for different sound signals.

FIG. 7 shows sound source recognition percentage of results classified by applying a sound source classification method of the present disclosure to a sound source feature extracted through a Mel-Frequency Cepstral Coefficient (MFCC) feature extraction method and a Gammatone (GFCC) feature extraction method.

### DETAILED DESCRIPTION

Exemplary embodiments now will be described more fully hereinafter with reference to the accompanying drawings and the disclosure set forth in the drawings, while the scope of protection sought is not limited or defined by the exemplary embodiments.

Although general terms as currently widely used as possible are selected as the terms used in the present disclosure while taking functions in the present disclosure into account, they may vary according to an intention of those of ordinary skill in the art, judicial precedents, or the appearance of new technology. In addition, in specific cases, terms intentionally selected by the applicant may be used, and in this case, the meaning of the terms will be disclosed in corresponding description of the present disclosure. Accordingly, the terms used in the present disclosure should be defined not by simple names of the terms but by the meaning of the terms and the content over the present disclosure.

The embodiments described herein may take the form of entirely hardware, partially hardware and partially software, or entirely software. The term “unit”, “module”, “device”, “robot” or “system” as used herein is intended to refer to a computer-related entity, either hardware, a combination of hardware and software, or software. For example, a unit, module, device, robot or system may refer to hardware constituting a part or the entirety of a platform and/or software such as an application for running the hardware.

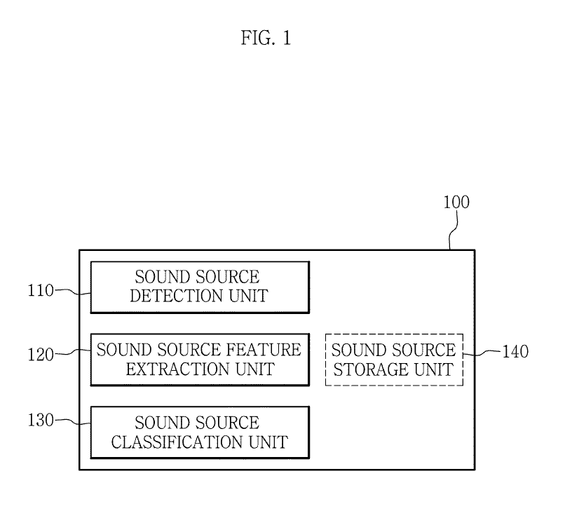

FIG. 1 is a diagram showing configuration of a sound classification device according to an exemplary embodiment of the present disclosure. The sound classification device 100 includes a sound source detection unit 110, a sound source feature extraction unit 120, and a sound source classification unit 130. Also, the sound classification device 100 may further include a sound source storage unit 140 as an optional component.

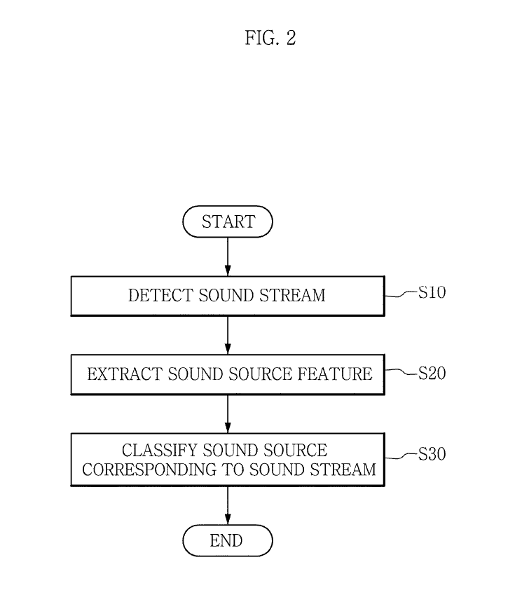

The sound source detection unit 110 may detect a sound stream for a preset period when a sound signal is generated. The sound source detection unit 110 may determine whether a sound signal is generated from an obtained (for example, inputted or received) sound signal, and when it is determined that the sound signal is generated, may detect a sound stream for a preset period from a point in time at which the sound signal is generated. In an embodiment, the sound source detection unit 110 may receive an input of a sound signal from a device which records sound signals generated from surrounding environment, or may receive a sound signal previously recorded and stored in the sound source storage unit 140 from the sound source storage unit 140, but is not limited thereto, and the sound source detection unit 110 may obtain the sound signal through various methods. The sound source detection unit 110 will be described in detail below with reference to FIG. 2.

The sound source feature extraction unit 120 may extract a sound source feature from the detected sound stream. In an embodiment, the sound source feature extraction unit 120 may divide the detected sound stream into a plurality of sound frames, and extract a sound source feature for each of the plurality of sound frames. For example, the sound source feature extraction unit 120 may divide the detected sound stream (for example, a sound stream of 500 ms) into ten sound frames of 50 ms, and extract a sound source feature for each of ten sound frames (first to tenth sound frames). In another embodiment, the sound source feature extraction unit 120 may extract a sound source feature from the detected entire sound stream, and divide the sound source feature by sound frames. The sound source feature extraction unit 120 will be described in detail below with reference to FIG. 2.

The sound source classification unit 130 may classify each sound frame into one of pre-stored reference sound sources based on the extracted sound source feature. That is, the sound source classification unit 130 may classify the sound stream by time frames based on the extracted sound source feature. Here, the reference sound source refers to a sound source as a reference for classifying a sound source from the sound source feature, and includes various types of sound sources, for example, a scream, a dog's bark, and a cough. In an embodiment, the sound source classification unit 130 may obtain the reference sound source from the sound source storage unit 140.

Further, the sound source classification unit 130 may analyze a correlation between the classified reference sound sources using the classification results. In an embodiment, the sound source classification unit 130 may analyze a correlation between the classified reference sound sources by calculating a sound source selection ratio C_{P} and a sound source correlation ratio CN_{P} for each reference sound source using the classification results. Here, the sound source selection ratio C_{P} refers to a ratio at which the reference sound source is selected as a sound source corresponding to each sound frame, and the sound source correlation ratio CN_{P} refers to a correlation between the reference sound sources.

Further, the sound source classification unit 130 may finally classify the sound stream using the analyzed correlation. In an embodiment, the sound source classification unit 130 may calculate a Joint Ratio (JR) that equals the sound source selection ratio multiplied by the sound source correlation ratio for each reference sound source, and finally classify the sound stream into one of the classified reference sound sources based on the joint ratio.

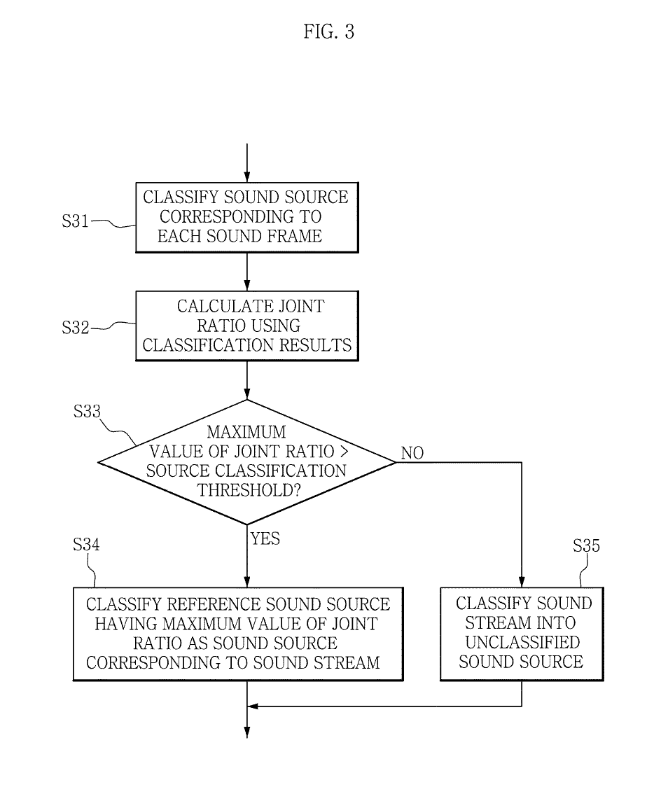

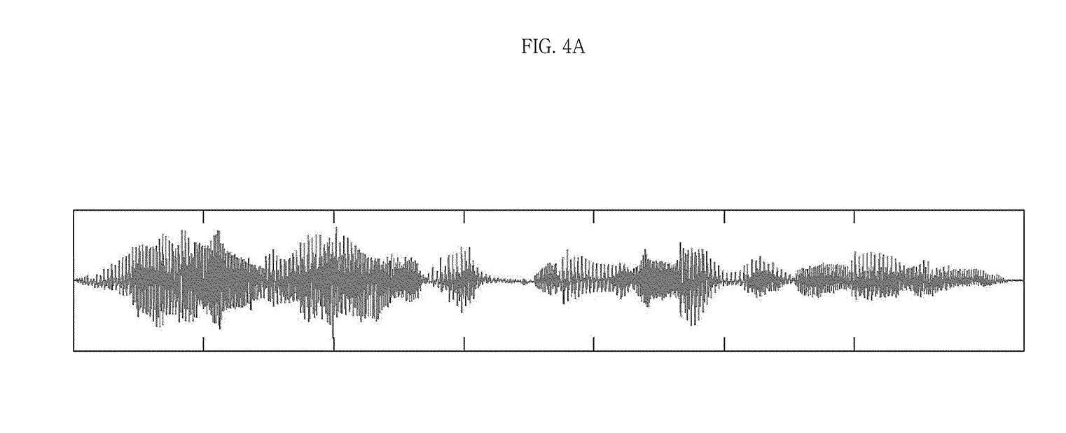

The sound source classification unit 130 will be described in detail below with reference to FIGS. 2 and 3.

Also, the sound source storage unit 140 as an optional component may store information associated with the reference sound sources used for sound source classification, the target sound signal for sound source classification, and the detected sound stream. In the specification, the sound source storage unit 140 may store the information using various storage devices including hard disks, random access memory (RAM), and read-only memory (ROM), while the type and number of storage devices is not limited in this regard.

FIG. 1 is a diagram showing configuration according to an exemplary embodiment of the present disclosure, in which blocks found separated depict the components of the device logically distinguishably. Thus, the foregoing components of the device may be mounted as a single chip or multiple chips according to the design of the device.

FIG. 2 is a flowchart of a sound classification method according to an exemplary embodiment of the present disclosure.

Referring to FIG. 2, the sound classification method may include detecting a sound stream for a preset period when a sound signal is generated through the sound source detection unit (S10).

At S10, the sound source detection unit may determine whether a sound signal is generated based on whether a difference between a amplitude of the sound signal (for example, a amplitude of a power value) and a amplitude of a background noise signal (for example, a amplitude of a power value) is greater than a preset detection threshold. When the difference is greater than the preset detection threshold, the sound source detection unit may determine that a sound signal is generated, and detect a sound stream for a preset period (for example, about 500 ms) from a point in time at which the sound signal is generated. In this case, the sound source detection unit may store the detected sound stream in a memory. When the difference is smaller than the preset detection threshold, the sound source detection unit may determine that a sound signal is not generated, and continue to determine whether a sound signal is generated from an obtained sound signal.

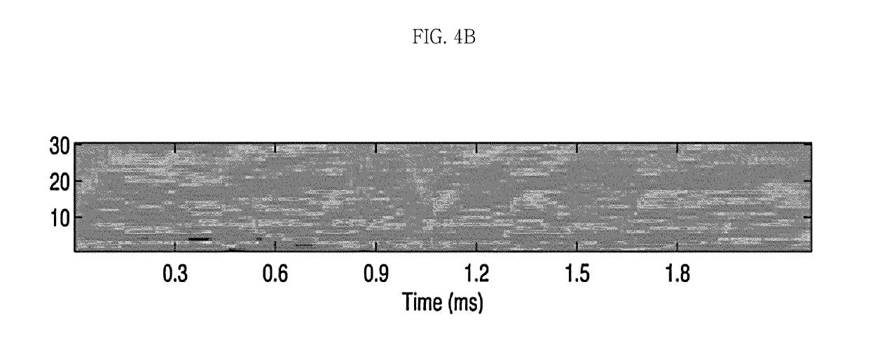

FIG. 4A shows an exemplary waveform of the sound stream detected by the sound source detection unit. As shown in FIG. 4A, the detected sound stream shows sound pressure variations over time, which may be extracted as a sound source feature by the sound source feature extraction unit as described below.

Subsequently, the sound classification method may include extracting a sound source feature from the detected sound stream through the sound source feature extraction unit (S20).

At S20, the sound source feature extraction unit may extract a sound source feature of the detected sound stream by a Gammatone Frequency Cepstral Coefficient (GFCC) feature extraction method. In an embodiment, the sound source feature extraction unit may extract a sound source feature for each of the plurality of sound frames using the GFCC method.

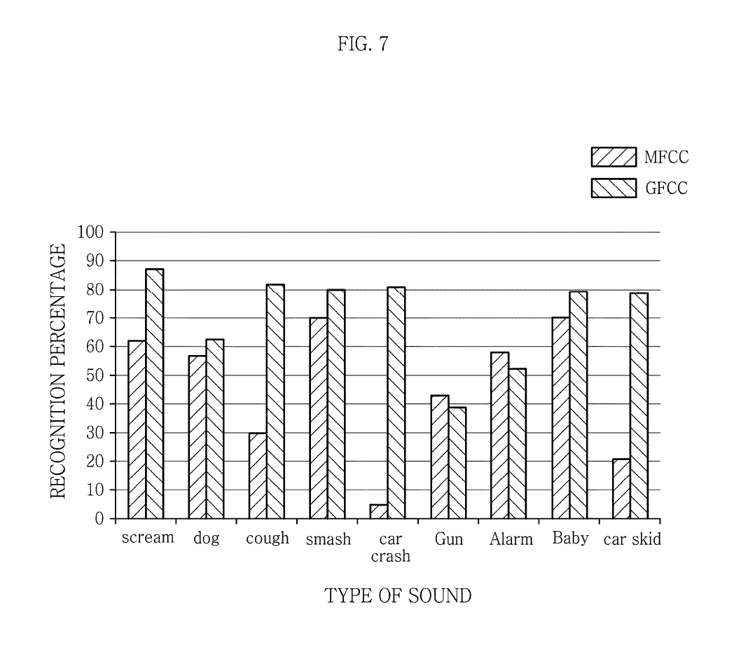

Describing in detail, the sound source feature extraction unit may extract a sound source feature by determining an energy flow on a time-frequency space for the detected sound stream through simulation modeling of auditory signal processing by the human auditory system, and performing discrete cosine transform of these values in a frequency domain to calculate a GFCC value. The foregoing method is a method commonly used in the signal processing field, and a detailed description is omitted herein. The foregoing feature extraction method by a GFCC technique may perform feature extraction by simpler calculation than a feature extraction method by a Mel-Frequency Cepstral Coefficients (MFCC) technique known in the art, and the extracted feature has a more robust property to environmental noise. A detailed description will be provided below with reference to FIG. 7.

FIG. 4B shows feature space representation of the sound source feature extracted from the sound stream of FIG. 4A by the sound source feature extraction unit. In FIG. 4B, an x axis is a time value, and a y axis is a frequency value corresponding to the time value.

Subsequently, the sound classification method may include classifying (determining) a sound source corresponding to the sound stream based on the extracted sound source feature (S30). A detailed description is provided below with reference to FIG. 3.

FIG. 3 is a detailed flowchart showing the sound source classification step in the sound classification method according to an exemplary embodiment of the present disclosure. More particularly, FIG. 3 is a detailed flowchart showing the step in which the sound classification device classifies a sound source through the sound source classification unit.

Referring to FIG. 3, the sound source classification unit may classify a sound source corresponding to each sound frame based on the extracted sound source feature (S31). That is, the sound source classification unit may classify the sound frame by time frames based on the extracted sound source feature.

At S31, the sound source classification unit may classify each sound frame into one of pre-stored reference sounds based on the extracted sound source feature using a predetermined classification technique. The predetermined classification technique refers to classification technique used for classifying binary data, such as classification technique using a multi-class linear Support Vector Machine (SVM) classifier, classification technique using artificial neural network, Nearest neighbor method and random forest technique. In the specification, the SVM classifier refers to a SVM classifier determined through a training process beforehand using feature data of about 4000 sound sources for classification in order to provide reliable performance.

Describing the foregoing sound classification method by example, the sound source classification unit may classify the sound frame by time frames (“binary type” classification) by determining which reference sound source is the sound source feature of the first sound frame similar to among a pair of reference sound sources (“reference sound source pair”) using the SVM classifier. In this instance, the sound source classification unit performs the “binary type” classification operation for each of reference sound source pairs of all combinations that may be made from the reference sound sources. Further, the sound source classification unit may classify a most selected reference sound source as a sound source corresponding to the first sound frame through the “binary type” classification of the reference sound source pairs of all combinations. Further, the sound source classification unit may repeatedly perform the foregoing process on all the other sound frames (for example, second to tenth sound frames) to classify a sound source corresponding to each sound frame.

Subsequently, the sound source classification unit may calculate a joint ratio by analyzing a correlation between the classified reference sound sources using the classification results (S32). Here, the joint ratio refers to a ratio representing a correlation between the classified sound sources, and may be expressed as a sound source selection ratio multiplied by a sound source correlation ratio as shown in Equation 1 below.

### [Equation 1]

JR=C_{R}×CN_{R}

Here, JR denotes the joint ratio, C_{P} denotes the sound source selection ratio, and CN_{P} denotes the sound source correlation ratio. The joint ratio indicates the classification reliability of the multi-class classification, and when sound source classification is conducted using the joint ratio, there is an advantage of providing a user with reliability of the classified sound source.

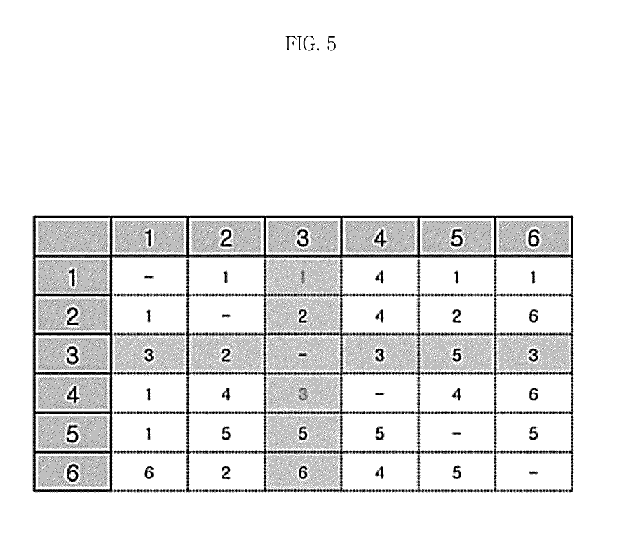

In an embodiment, the sound source classification unit 130 may calculate the sound source selection ratio C_{P} using the individual classification results of each sound frame. Further, the sound source classification unit 130 may calculate the sound source correlation ratio CN_{P} using the comprehensive classification results (for example, a correlation ratio matrix) of all the “binary type” classification performed for classification of each sound frame. A method of calculating the sound source correlation ratio through the correlation ratio matrix will be described in detail below with reference to FIG. 5. Further, the sound source classification unit 130 may calculate the joint ratio for each sound frame based on the calculated sound source selection ratio and sound source correlation ratio.

Subsequently, the sound source classification unit may determine a joint ratio having a maximum value among the joint ratios for each reference sound source, and compare the maximum value of the determined joint ratio to a preset classification threshold (S33).

When the maximum value of the joint ratio is greater than the classification threshold, the sound source classification unit may finally classify a reference sound source having the maximum value of the joint ratio as a sound source corresponding to the sound stream (S34). Through this, the sound classification device may provide more accurate classification results than other sound classification devices that finally classify a sound corresponding to an entire sound stream by using only classification (selection) results of individual sound frames. Particularly, even in the case where it is difficult to classify the sound stream into a particular sound source, such as, for example, the case where a similar number of selections are yielded for each reference sound source, the sound classification device according to an exemplary embodiment of the present disclosure may classify the sound stream more effectively by classifying the sound source using information associated with the correlation between each reference sound source. Further, a process of calculating the joint ratio is a relatively very simple calculation process as compared to other methods, so the sound classification device has the benefit of classifying sound sources in real time through this simple calculation process.

When the maximum value of the joint ratio is smaller than the classification threshold, the sound source classification unit may finally classify the sound stream into an unclassified sound source which is not classified by the reference sound sources (S35). As an embodiment, when the sound stream is finally classified into the unclassified sound source, the sound source classification unit may provide a user with reference sound sources having top ranking joint ratios (for example, having top three values of the joint ratios) together with the corresponding values of the joint ratios. Through this, the user may determine the classification reliability through the provided joint ratios, and manually classify the sound source corresponding to the sound stream.

FIG. 5 shows an exemplary correlation ratio matrix. The correlation ratio matrix is a matrix representing the comprehensive results of all the “binary type” classification performed for classification of the sound stream. For example, when determination is made as to which reference sound source is the sound feature extracted for each time frame of the sound stream (for example, each sound frame) similar to among reference sound source 1 (class 1) and reference sound source 3 (class 3), if the number of determinations of reference sound source 1 is larger than the number of determinations of reference sound source 3, “1” indicating reference sound source 1 is entered on column 1 and row 3 of the correlation ratio matrix. In the same way, for all the time frames, results of comparing to the reference sound source pairs of all combinations are entered on columns and rows of the correlation ratio matrix as shown in Table 1.

When the correlation matrix is calculated by the foregoing process, a sound source processing device may calculate a sound source correlation ratio for each reference sound source using the correlation matrix. For example, the sound source processing device may calculate a sound source correlation ratio for reference sound source 3 by calculating a ratio of the number of selections of reference sound source 3 from correlation ratio matrix values (for example, all values on column 3 and row 3) between the other reference sound sources compared to reference sound source 3. Referring to Table 1, as a result of the calculation, the sound source correlation ratio for reference sound source 3 equals 4/10=0.4. In the same way, sound source correlation ratios for all the reference sound sources may be calculated.

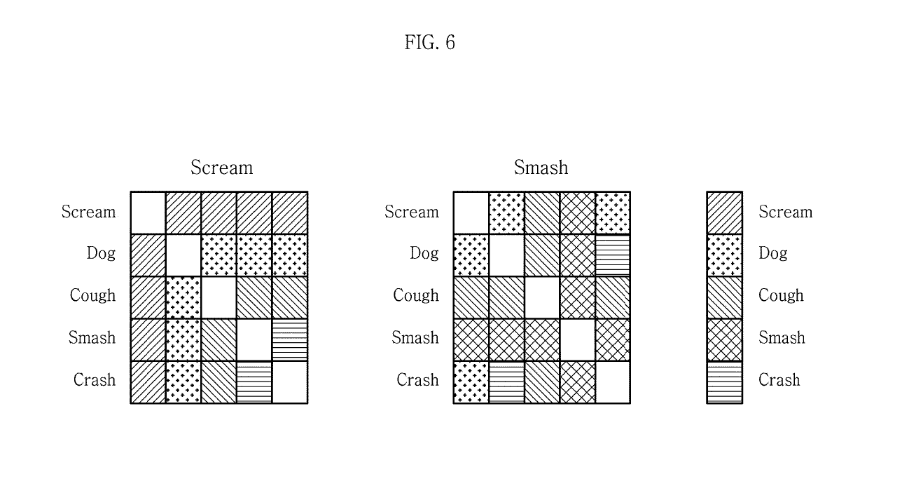

FIG. 6 is a diagram showing an exemplary sound source correlation ratio for different sound signals. More particularly, illustration on the left side of FIG. 6 shows a sound source correlation ratio for a “scream” sound signal, and illustration on the right side of FIG. 6 shows a sound source correlation ratio for “smash”. Also, colors presented on the right side of FIG. 6 stand for colors representing exemplary reference sound sources.

FIG. 7 shows sound source recognition percentage of results classified by applying the sound source classification method of the present disclosure to the sound source feature extracted through a MFCC feature extraction method and a GFCC feature extraction method. Here, MFCC is one of sound feature extraction methods commonly used in the sound recognition field. FIG. 7 shows a comparison of sound source classification results under the same conditions except a feature extraction method. Referring to the comparison results of FIG. 7, it can be seen that sound source classification results obtained through the method presented in the present disclosure generally exhibit a higher recognition percentage than sound source classification results obtained through a MFCC method.

The sound classification method may be embodied as an application or a computer instruction executable through various computer components and recorded in computer-readable recording media. The computer-readable recording media may include a computer instruction, a data file, a data structure, and the like, singularly or in combination. The computer instruction recorded in the computer-readable recording media may be not only a computer instruction designed or configured specially for the present disclosure, but also a computer instruction available and known to those of ordinary skill in the field of computer software.

The computer-readable recording media includes hardware devices specially configured to store and execute a computer instruction, for example, magnetic media such as hard disks, floppy disks, and magnetic tape, optical media such as CD ROM disks and digital video disc (DVD), magneto-optical media such as floptical disks, ROM, RAM, flash memories, and the like. The computer instruction may include, for example, a high level language code executable by a computer using an interpreter or the like, as well as machine language code created by a compiler or the like. The hardware device may be configured to operate as at least one software module to perform processing according to the present disclosure, or vice versa.

While the preferred embodiments have been hereinabove illustrated and described, the present disclosure is not limited to the above mentioned particular embodiments, and various modifications may be made by those of ordinary skill in the technical field to which the present disclosure pertains without departing from the essence set forth in the appended claims, and such modifications shall not be construed separately from the technical features and aspects of the present disclosure.

Further, the present disclosure describes both a product method and a method product, and the description of both inventions may be complementarily applied as needed.

What is claimed is:

1. A sound classification device comprising:
a sound source detection unit configured to detect a sound stream for a preset period when a sound signal is generated;
a sound source feature extraction unit configured to divide the detected sound stream into a plurality of sound frames, and extract a sound source feature for each of the plurality of sound frames; and
a sound source classification unit configured to classify each of the sound frames into one of pre-stored reference sound sources based on the extracted sound source feature, analyze a correlation between the classified reference sound sources using the classification results, and finally classify the sound stream using the analyzed correlation.

2. The sound classification device according to claim 1, wherein the sound source detection unit is further configured to detect the sound stream when a difference between a amplitude of the sound signal and a amplitude of a background noise signal is greater than a preset detection threshold.

3. The sound classification device according to claim 1, wherein the sound source feature extraction unit is further configured to extract the sound source feature for each of the plurality of sound frames by a Gammatone Frequency Cepstral Coefficient (GFCC) technique.

4. The sound classification device according to claim 1, wherein the sound source classification unit is further configured to classify each of the sound frames into one of the pre-stored reference sound sources based on the extracted sound source feature, using a multi-class linear Support Vector Machine (SVM) classifier.

5. The sound classification device according to claim 1, wherein the sound source classification unit is further configured to analyze the correlation between the classified reference sound sources by calculating a sound source selection ratio representing a sound source selection ratio of each of the reference sound sources and a sound source correlation ratio representing a correlation ratio between the reference sound sources using the classification results.

6. The sound classification device according to claim 5, wherein the sound source classification unit is further configured to calculate a joint ratio that equals the corresponding sound source selection ratio multiplied by the corresponding sound source correlation ratio for each of the reference sound sources, and finally classifie the sound stream into one of the classified reference sound sources based on the joint ratio.

7. The sound classification device according to claim 6, wherein the sound source classification unit compares a maximum value of the joint ratio to a preset classification threshold, and when the maximum value of the joint ratio is greater than the classification threshold, finally classifies the sound stream into the reference sound source having the maximum value of the joint ratio.

8. The sound classification device according to claim 7, wherein the sound source classification unit finally classifies the sound stream into an unclassified sound source that is not classified by the reference sound sources, when the maximum value of the joint ratio is smaller than the classification threshold.

9. The sound classification device according to claim 8, wherein the sound source classification unit is further configured to provide a user with the reference sound sources having top three values of the joint ratios together with the corresponding values of the joint ratios, when the sound stream is finally classified into the unclassified sound source.

10. A sound classification method comprising:
detecting a sound stream for a preset period when a sound signal is generated;
dividing the detected sound stream into a plurality of sound frames, and extracting a sound source feature for each of the plurality of sound frames; and
classifying each of the sound frames into one of pre-stored reference sound sources based on the extracted sound source feature, analyzing a correlation between the classified reference sound sources using the classification results, and classifying the sound stream using the analyzed correlation.

11. The sound classification method according to claim 10, wherein the detecting of the sound source stream comprises detecting the sound stream when a difference between a amplitude of the sound signal and a amplitude of a background noise signal is greater than a preset detection threshold.

12. The sound classification method according to claim 10, wherein the extracting of the sound source feature comprises extracting the sound source feature for each of the plurality of sound frames by a Gammatone Frequency Cepstral Coefficient (GFCC) technique.

13. The sound classification method according to claim 10, wherein the classifying of the sound stream comprises classifying each of the sound frames into one of the pre-stored reference sound sources based on the extracted sound source feature, using a multi-class linear Support Vector Machine (SVM) classifier.

14. The sound classification method according to claim 10, wherein the classifying of the sound stream comprises analyzing the correlation between the classified reference sound sources by calculating a sound source selection ratio representing a sound source selection ratio of each of the reference sound sources and a sound source correlation ratio representing a correlation ratio between the reference sound sources using the classification results.

15. The sound classification method according to claim 14, wherein the classifying of the sound stream comprises calculating a joint ratio that equals the corresponding sound source selection ratio multiplied by the corresponding sound source correlation ratio for each of the reference sound sources, and finally classifying the sound stream into one of the classified reference sound sources based on the joint ratio.

16. The sound classification method according to claim 15, wherein the classifying of the sound stream comprises comparing a maximum value of the joint ratio to a preset classification threshold, and when the maximum value of the joint ratio is greater than the classification threshold, finally classifying the sound stream into the reference sound source having the maximum value of the joint ratio.

17. The sound classification method according to claim 16, wherein the classifying of the sound stream comprises finally classifying the sound stream into an unclassified sound source that is not classified by the reference sound sources, when the maximum value of the joint ratio is smaller than the classification threshold.

18. The sound classification method according to claim 17, wherein the classifying of the sound stream comprises providing a user with the reference sound sources having top three values of the joint ratios together with the corresponding values of the joint ratios, when the sound stream is finally classified into the unclassified sound source.
